(19) United States
(12) Patent Application Publication
(10) Pub. No.: US 2008/0009242 A1
(43) Pub. Date: Jan. 10, 2008

(54) Underground data communications system

(76) Inventors: Mark Rhodes, West Lothian (GB); Brendan Hyland, Edinburgh (GB)

Correspondence Address: HELLER EHRMAN LLP, 275 MIDDLEFIELD ROAD, MENLO PARK, CA, 94025-3506, US

(21) Appl. No.: 11/771,140

(22) Filed: Jun. 29, 2007

Related U.S. Application Data
(60) Provisional application No. 60/830,007, filed on Jul. 10, 2006.

(51) Int. Cl. H04B 13/02

(52) U.S. Cl. 455/40

(57) ABSTRACT

A data communication system includes a transmitter. The transmitter transmits data in a digitally modulated electromagnetic or magnetic signal. A receiver is provided for receiving the digitally modulated electromagnetic or magnetic signal. At least one of the transmitter and receiver is below ground and has a magnetically coupled antenna.

### CROSS REFERENCE TO RELATED APPLICATIONS

This application claims the benefit of U.S. Ser. No. 60/830,007 filed Jul. 10, 2006, which application is fully incorporated herein by reference.

### BACKGROUND

1. Field of the Invention

The present invention relates generally to data communication systems, and more particularly to data communication systems that provide low bit-rate telemetry data links with communication stations via an underground communication paths.

2. Description of the Related Art

Many elements of plant and equipment installed as parts of public utility provision or distributed industrial plants require a degree of monitoring and/or control by a central site or other location. For example, the on or off condition of valves and sensors installed with sewage or water pipes may require to be verified periodically. In general, monitoring of this type does not require large volumes of data to be transferred, but merely a few bits perhaps only on a periodical or occasional basis. For practical reasons relating to difficulties of cable routing, installation and vulnerability to damage, it is often impracticable to install and maintain a communication cable for this purpose between the communication site and the monitoring site. For these reasons, a conventional local radio communication link is an attractive alternative for communicating the condition of a plant element or to control it.

Conventional radio links are often used. However, there are many occasions when such an installation cannot be deployed, or to do so is disruptive, aesthetically unattractive in the environment or expensive. For example, the plant element to be monitored may be underground beneath a busy urban main road accessible, if at all, only by manhole. In such a position, there may be no convenient vantage point to locate a conventional above ground radio antenna and to route its attendant feeder cable from the underground site to the antenna. Also, the overall cost of installation and subsequent maintenance are likely to be prohibitive. Furthermore, neighbourhood amenity interest groups are likely to oppose such installations, and local government planning departments may disallow them. Thus a less disruptive, invisible and lower cost solution to the monitoring problem is needed.

One difficulty to be considered in communicating data underground is the relatively high attenuation encountered by an electromagnetic signal when transmitted through a medium of wet sub-soil, clay and rock. This arises largely from the partial conductivity that impure water imparts to the geological strata, and partly from the dry properties of the rock itself. For propagating electromagnetic waves the energy is continually cycling between magnetic and electric field. Although the predominant elements of rock and clay are comprised largely of minerals such as silica that have low conductivity, because of the presence of water, the underground medium is partially conductive and so the electric field component is attenuated due to conduction losses. This is a particular problem for conventional terrestrial radio systems, and means that the signals transmitted penetrate the ground very poorly. Since terrestrial radio systems are almost universally based on electrically coupled antenna systems, these antennas launch a predominantly electric field that is strongly attenuated by any surrounding partially conductive material. Because of this, known systems fail to achieve the significant transmission distances that are required for many practical applications.

### SUMMARY

Accordingly, an object of the present invention is to provide a data communication system with at least a transmitter or receiver located underground and has a magnetically coupled antenna.

Another object of the present invention is to provide a data communication system with lower transmission losses compared to conventional electromagnetic antennas used in free space.

Still another object of the present invention is to provide a data communication system with a purely magnetic field that is relatively unaffected by free space.

Yet another object of the present invention is to provide a data communication system that uses very low frequencies.

These and other objects of the present invention are achieved in, a data communication system. A transmitter is provided for transmitting data in a digitally modulated electromagnetic or magnetic signal. A receiver receives the digitally modulated electromagnetic or magnetic signal. At least one of the transmitter or receiver is below ground and has a magnetically coupled antenna.

In another embodiment of the present invention, a monitoring system is provided with at least one sensor or detector for sensing a state or condition that is monitored. A transmitter is provided for transmitting a digitally modulated electromagnetic or magnetic signal indicative of the state or condition.

In another embodiment of the present invention, a communication method is provided. A signal is transmitted from a transmitter to a receiver. At least one of the transmitter and receiver has a magnetically coupled antenna. At least one of the transmitter and receiver is located underground and at least part of a communication path is underground.

### BRIEF DESCRIPTION OF THE DRAWINGS

FIG. 1 is a schematic diagram illustrating one embodiment of a point-to-point underground communication system of the present invention.

FIG. 2 is a block diagram of a transmitter for use in the link of FIG. 1.

FIG. 3 is a block diagram of a receiver for use in the link of FIG. 1.

FIG. 4 is a plot of power attenuation with respect to signal frequency for an electromagnetic signal propagating through three types of underground strata: wet clay, wet sandstone and dry sandstone, together with the comparable plot for impure fresh water.

FIG. 5 illustrates an embodiment of a system of the present invention with two signal propagation paths, one totally through the ground and one partially through the ground and partially through air.

FIG. 6(a) illustrates a loop or coil antenna that can have a large diameter for use in the communications systems of FIGS. 1 and 5;

FIG. 6(b) represents another loop antenna in which a rod of high permeability material is introduced into the coil to form a solenoid of more compact form.

FIG. 7 illustrates an embodiment of the present invention with multiple sites with data transferred successively with multiple links in tandem to achieve greater distance or consume lower energy.

### DETAILED DESCRIPTION

In one embodiment of the present invention, a data communication data link is provided that is either wholly or partially underground. Because it is very different from air, the underground environment requires radically new methods of communication from those applicable for air propagation systems. This is primarily because underground geological strata and deposits exhibit much higher attenuation of the signal over distance. To overcome the problem of high attenuation, magnetic coupled antennas are used.

Magnetic antennas, formed by a wire loop, coil or similar arrangement, create both magnetic and electromagnetic fields. They launch a predominantly magnetic field that transitions to the characteristic impedance relationship between E and H components over an area known as the near field. The magnetic or magneto-inductive field is generally considered to comprise two components of different magnitude that, along with other factors, attenuate with distance (r) at rates including a factor proportional to 1/r² and 1/r³ respectively. Together these are often termed the near field components. The electromagnetic field has a still different magnitude and, along with other factors, attenuates with distance at a rate including a factor proportional to 1/r. It is often termed the far field or propagating component. The far field is the area in which the electromagnetic transmission signal has transitioned to the characteristic impedance relationship between E and H components. The near field dominates at short distances, whereas the far field is relatively stronger at greater distances. Dependent on distance between the transmit antenna and the receive antenna, either or both near and far field components may be used. Using a magnetic coupled antenna rather than an electrically coupled antenna reduces signal dissipation in the near field, but allows data transmission in the near and far fields.

In the underground environment, using electrically insulated magnetically coupled antennas provides various advantages over the alternative of electrically coupled antennas. In far field electromagnetic propagation, the relationship between the electric and magnetic field is determined by the characteristic or intrinsic impedance of the transmission medium. An electrically coupled antenna launches a predominantly electric field that transitions to the characteristic impedance over the near field. Underground attenuation is largely due to the effect of conduction on the electric field. Since electrically coupled antennas produce a higher E-field component in the near field the radiated signal experiences higher attenuation. The same performance issues apply to a receive antenna. Magnetically coupled antennas do not suffer from these problems and so are more efficient underground than electrically coupled antennas.

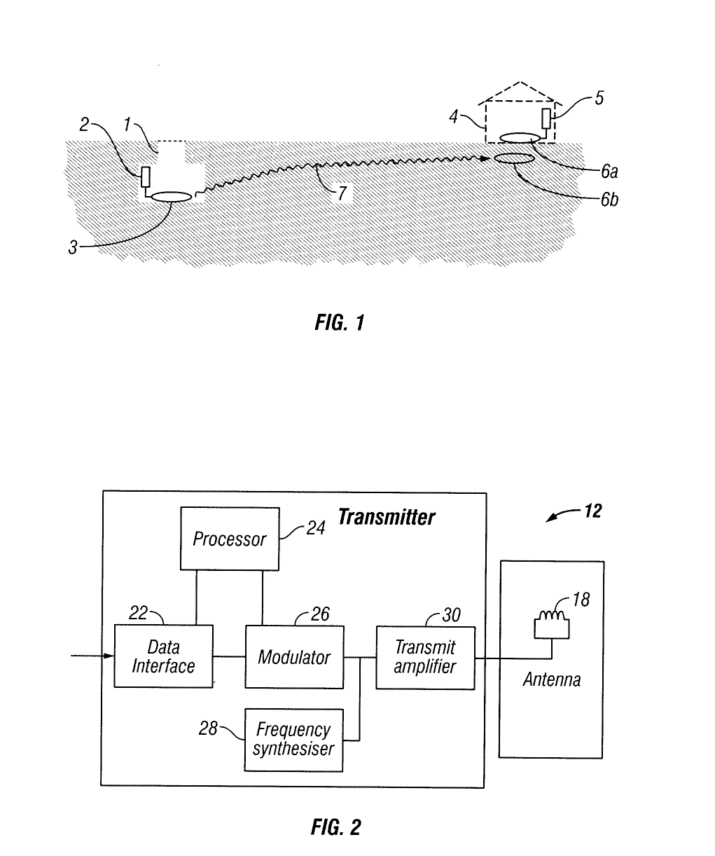

FIG. 1 illustrates one embodiment of an underground data communication system of the present invention. This is located in an underground manhole 1 that contains an element of equipment requiring to be monitored or controlled (not shown). Associated with the equipment being monitored and also underground is a digital communications module 2 that is connected to an antenna 3. The digital communications module 2 may be any one of a transmitter or receiver or transceiver. The antenna 3 may be a coil or loop of conducting wire. The shape of the coil is not critical but its area ideally should be maximised for greatest signal, especially when a low frequency signal is used. The coil may have its size limited by the space available but the best performance is usually achieved if the coil has as great an effective area as possible because this creates a large magnetic signal flux for transmitting and intercepts more flux for receiving, both of which increase the received signal or enable performance over longer distance. For example, the coil may have a cross sectional area of greater than 0.2 metres squared. Multiple turns of one or both coils are usually beneficial because this also increases the signal flux created by a transmit coil antenna and the voltage induced in a receive coil antenna.

The communications module 2 includes circuits and components of a generally conventional nature to generate and/or receive a carrier signal, usually of low frequency, and modulation to represent the data to be transmitted and/or demodulation to demodulate the signal received. An example of a transmitter that is suitable for use in the communications module 2 is shown in FIG. 2. This has a data interface 22 for receiving data that is to be transmitted. This may be connected to the equipment (not shown) that it is be monitored or controlled to provide a source of the necessary state/condition and/or control data. The data interface 26 is connected to each of a processor 24 and a modulator 26.

The modulator 26 is provided to digitally encode data onto a carrier wave. At an output of the modulator 26 are a frequency synthesiser 28 that provides a local oscillator signal for up-conversion of the modulated carrier and a transmit amplifier 30, which is connected to an electrically insulated magnetic coupled antenna 18. In use, the transmitter processor 24 is operable to cause digitally modulated electromagnetic communication signals to be transmitted via the antenna at a selected carrier frequency. When data is to be transmitted to the remote site 4, the transmitter generates a signal with modulation representing data used to control or modify the state of the remote plant element. Where elementary control is adequate, modulation of the signal may be a simple on-off action to indicate state or condition or to command a state or condition.

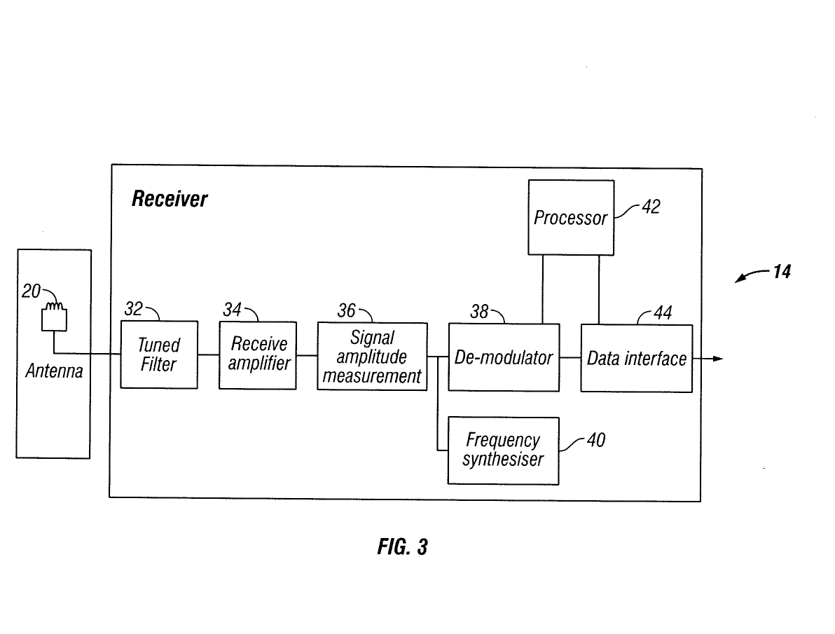

Digitally modulated data transmitted from the communications module 2 is received at an antenna that may be above 6a or below 6b ground and passed to another communications module 5 at a remote site 4. FIG. 3 shows an example of a receiver 14 for use in communications module 5. As with the transmitter, the antenna 6a, 6b is an electrically insulated magnetic antenna 20. Connected to the antenna 20 is a tuned filter 32 that is in turn connected to a receive amplifier 34. At the output of the amplifier 34 is a signal amplitude measurement module 36 that is coupled to a de-modulator 38 and a frequency synthesiser 40, which provides a local oscillator signal for down conversion of the modulated carrier. Connected to the de-modulator 38 are a processor 42 and a data interface 44, which is also connected to the processor 42. The data interface 44 is provided for transferring data to control the state of a plant element (not shown). The receiver 5 may be connected to monitoring equipment (not shown) to display received information about the condition of the remote plant element.

In the preceding, the communications module 2 is described as having a transmitter and the communications module 5 is described as having a receiver, in one embodiment both can be transceivers and be operable as both a transmitter and receiver for monitoring and control, but usually at different times.

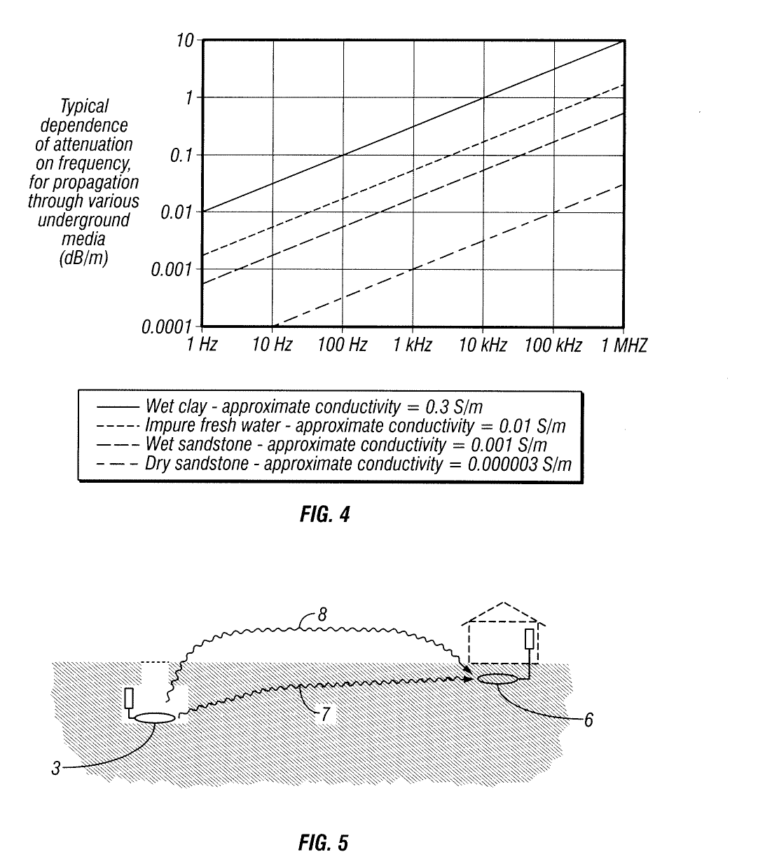

In an electrically dissipative medium, such as underground wet rock and clay, consideration of the power attenuation of electromagnetic signals with distance is important. In the case of a uniformly dissipative medium the attenuation of an electromagnetic signal, when conventionally expressed in decibels, increases in almost direct proportion to the square root of frequency within the frequency range shown. This is best seen from FIG. 4, which depicts approximate electromagnetic signal attenuation rates for certain typical underground media. The mineral conductivities are noted on FIG. 4 in Siemens per meter (S/m). The attenuation of the electromagnetic signal is expressed in decibels for each metre of lineal propagation distance. The data of FIG. 4 is shown for the purposes of illustration. It will be understood that the properties of rock strata cannot be precise for every situation because the underground composition will vary considerably in practice. Any actual attenuation encountered underground will be somewhat dependent on the composition of the strata and its content of water and natural mineral salts, all of which may affect its electrical conductivity, and so these graphs can only be representative approximations.

Propagating EM signals that have lower frequencies have very significantly lower rates of attenuation for than higher frequency signals. In most conventional communications applications, very low frequency carrier signals are considered unattractive because they cannot in practice be used to convey modulated information of useful rates. This is not the case for the telemetry applications to which this invention can be applied, where very low information bit rates are adequate. By adopting low frequencies that have low attenuation in underground transmission, it is possible to meet the needs of low bit-rate data communication with unobtrusive and conveniently located antennas and equipment underground.

The optimum frequency of operation is dependent on the situation and requirements (including strata, distance required, information bit-rate required, and any interfering signals), but will usually be in the region of 100 Hz to 100 kHz. If the telemetry information to be conveyed is of a very elementary binary nature, for example the on/off condition of a valve or the true/false condition of a pressure sensor detecting the presence of a liquid and required only occasionally such as every 15 minutes, then the required information rate is very low. Such an application allows very low signal frequencies to be adopted with the advantage that greater distance can be achieved. For example, to benefit from the greatest distance at very low telemetry rates, frequencies in the range 1 to 10 kHz will often be ideal.

When information requires to be sent only at extremely low rates, the binary information bandwidth is also extremely low, in the order of 0.001 Hz for this example of binary state changes communicated only every 15 minutes (or 900 seconds). Such very low information rates allow very narrow bandwidth filtering to be applied to a received signal before the point in the receive system process where the state of the information carried by the signal is determined. Filtering to the minimum bandwidth possible is desirable to distinguish a weak wanted signal from amongst unavoidable attendant noise within the signal.

Filtering may be applied by conventional means using filter circuits, albeit unusually narrow, applied to the carrier frequency before demodulation of the signal and noise. For the received of FIG. 3 this means that a filter would be put before the demodulator, for example between the receiver amplifier and the signal amplitude measurement module. Alternatively, the demodulation process may be applied to the signal while still of significant bandwidth, and effective narrow filtering applied to the resultant demodulated information and attendant noise. For the receiver of FIG. 3, this means that the filter would be put after the demodulator. One option involves encoding the binary state information carried by the signal as a very long binary signal or word of very many subsidiary bits, where the two binary states to be conveyed are distinguished by two different words of the same subsidiary bit-rate. For example, the long word could potentially change to indicate an altered state every 900 seconds, and the subsidiary bits could be sent at a rate of 100 subsidiary bits/second, which together could provide words of 90,000 subsidiary bits in length. The two predetermined words may be pseudorandom binary words of known pattern, arranged so that their mutual cross-correlation function is very close to zero; in other words they are as easily distinguishable as possible.

Detecting which of the two possible words has been received is achieved by cross-correlating the demodulated but un-sliced signal with binary patterns representing both of the words, whereupon a decision is made as to which has been received by examining the two cross-correlation functions so derived. Correlation and associated methods will be familiar to those skilled in the art of digital communication, so no further implementation details need be given here. By adopting this method, the signal bandwidth in this example is comparable to the 100 bits/second rate of the subsidiary bits, but the information bandwidth after correlation and binary decision is very much less. This markedly reduces the effect of unwanted noise and enables greater system distance and reliability to be achieved. As will be recognised, this principle could be extended readily to the use of more than two long words to represent and communicate more than two states.

In use, control and/or status data is captured from the equipment at site 1, digitally modulated onto a suitable carrier and transmitted over path 7 to the antenna 6a, 6b at site 4, which may be a central station operable for monitoring the distant plant element. Alternatively, site 4 may be a central station operable in a mode to control the state of the distant plant element, in which case the direction of signal transmission path 7 is the reverse of that shown. Site 4 may be operable to fulfill both monitoring and controlling roles. The station at site 4 and its component elements may or may not be underground. In some implementations, the site 4 may include a substantial building and environs, in which case benefit may be derived from using an antenna of larger area than is possible in a manhole, for this will increase the level of signal which can be transmitted and/or received, or increase effective distance, or both.

While the signal transmission loss is significant through the ground, often another propagation path of lesser loss also will exist between typical transmit and receive sites. For antennas only a modest distance below ground or close to the surface of the ground, as usually required by applications of this invention, a large part of the electromagnetic and magnetic fields from the transmit antenna will emanate above ground and, by the reciprocity principle of antennas, the receive antenna will be influenced by fields in a similar manner. For all but short distances, a path that includes air between transmitter and receiver will be of lower attenuation than that wholly through the ground. Consequently, much greater distance is possible than solely through the ground.

The present invention can utilise paths through the air and/or ground without special adaptation being essential. This considerably simplifies the design, manufacture, selection and deployment of systems based on it. FIG. 5 shows a system that utilises an additional communication path 8 between transmitting antenna 3 and receiving antenna 6. Especially in the case of a transmit antenna not far underground, part of its field will readily emanate above ground having suffered little attenuation over the short distance. From there, it is likely that the remaining attenuation of the ongoing path through the air to the receive antenna 6 will be significantly less than if the entire distance had been through the ground. Consequently, for transmit and/or receive antennas, which are relatively shallow under the ground, on the ground, or where one or other is above ground, greater communication distance can be achieved.

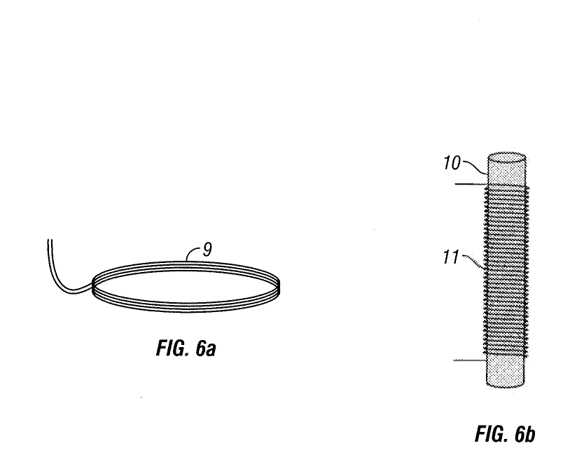

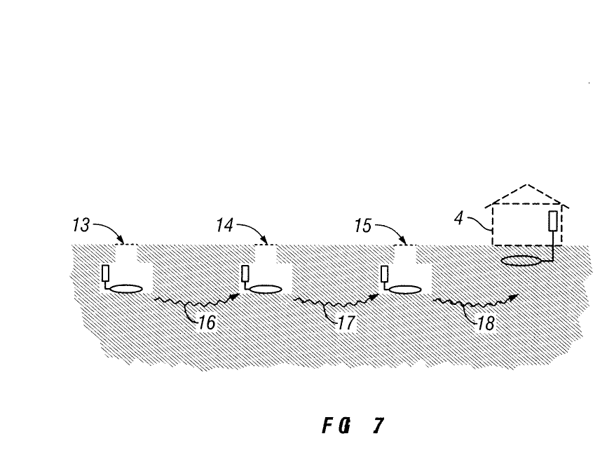

FIG. 6(a) illustrates an example antenna that can be used in any of the systems in which the invention is embodied. This has a magnetically coupled loop or coil of insulated conductor wire, usually of many turns. Especially for low frequencies, it is advantageously arranged to enclose as large an area as possible, for example greater than 0.2 metres squared. For a typical signal frequency of 5 kHz, the coil could have 100 turns and a diameter of 1 m, but circumstances at its deployed site may allow only a lesser diameter. FIG. 6(b) illustrates another antenna that can be used in any of the systems in which the invention is embodied. This is a coil antenna in which the coil is elongated into a solenoid and encloses a core of high-permeability ferromagnetic material such as ferrite, which greatly increases the flux created or intercepted by the coil. For greatest signal flux the ferrite core should be as large as practicable but, for typical core and coil proportions such as shown, the effectiveness of this arrangement is to increase the flux by about 50 to 100 times. Consequently, for a given performance, this arrangement allows a smaller antenna to be used.

FIG. 7 is another variation of the basic system of FIG. 1. This has a number of sites 13, 14 and 15 that are linked for tandem communication to central site 4 by means of successive path links 16, 17 and 18. An arrangement like this materially increases the total distance span over which monitoring or control can be achieved and/or enables lower transmit power to be used because the individual link distances are much reduced. It will be appreciated that the number of sites can vary as required, and that the depicted distances are for descriptive purposes and not necessarily to scale. For the case of monitoring applications, site 13 transmits its data over link path 16 to site 14; site 14 then relays the same data (or a representation of it) over link path 17 to site 15; site 15 then relays the same data over link path 18 to the central site 4. Intermediate sites 14 and 15 may have their own data conveyed in similar manner but require fewer link paths.

The data from each of multiple sites will require some form of distinguishing identification to be associated with it. This could be, for example, a recognisable feature of the digital encoding of the data such as a label or its temporal position in a predetermined polling sequence. Other identification techniques may be employed, such as different signal frequencies, multiple frequencies transmitted simultaneously or sequentially, or different modulation. Similarly, where the central site sends control commands to the remote sites, comparable identification is required so that the control data is recognised and implemented by the correct site. Whether or not a tandem arrangement similar to that depicted is used, identification of data destined for or originating from each site may be required if sites are within reception distance of data not intended for them.

In another embodiment, the central site can send query commands to remote sites which, when recognised, cause a remote site to respond with monitoring data indicating its condition. The commands could be sent in similar manner to those of FIG. 5, but in the reverse direction. An advantage of this query and response arrangement is that transmission energy, which may be from batteries, is conserved at the remote sites because the transmitter only requires to consume energy for sending monitoring data when that information is known to be required. Of course, the query and response arrangement is not limited to the tandem deployment outlined, but may be used over one or more independent point-to-point links between a central site and remote sites.

As another possible measure to preserve energy, the monitoring site could be operable to send data only when a significant change occurs in the state of the equipment; which is of a type that has to be notified to the central site. To check for continued operability of the remote parts of the system in such an arrangement, it may be desirable to poll each remote site occasionally for a response, perhaps once per day, whether otherwise needed or not, or to design the remote systems to send data autonomously on an occasional basis whether otherwise needed or not.

The present invention provides numerous advantages. In contrast to conventional radio antennas that must be situated in clear open space, the electromagnetic and magnetic techniques described herein allow operation of equipment underground to solve communication problems requiring relatively low information rates. By using a magnetically coupled EM antenna, communication equipment associated with the link can be co-located conveniently with any underground plant that is to be monitored or controlled. Accordingly, the installation is invisible to the public eye, of lower cost, and more robust and reliable than alternative methods.

A skilled person will appreciate that variations of the disclosed arrangements are possible without departing from the invention. For example, although most of the description herein assumes the most difficult underground environment for antennas, it will be recognised readily that antennas will often still be unobtrusive and conveniently located if they are merely close to the ground or inside an existing building housing associated plant, and indeed propagation advantages will ensue when such a location is possible. In addition, while the example of telemetry at low information rate has been used to illustrate the technique of underground communication, it will be appreciated that it has greater generality and can be applied to other applications requiring communication partly or wholly underground. Accordingly the above description of the specific embodiment is made by way of example only and not for the purposes of limitation. It will be clear to the skilled person that minor modifications may be made without significant changes to the operation described.

1. A data communication system, comprising:
a transmitter for transmitting data in a digitally modulated electromagnetic or magnetic signal; and
a receiver for receiving the digitally modulated electromagnetic or magnetic signal, wherein at least one of the transmitter and/or receiver is below ground and has a magnetically coupled antenna.

2. A communication system of claim 1, wherein the transmitter is operable to transmit information at a rate of less than 1000 bits per second.

3. A communication system of claim 1, wherein the transmitter is operable to transmit signals at a frequency of less than 100 kHz.

4. A communication system of claim 3, wherein the transmitter is operable to transmit signals at a frequency in the range of 100 Hz to 100 kHz.

5. A communication system of claim 4 wherein the transmitter is operable to transmit signals at a frequency in the range of 1 kHz to 10 kHz.

6. A communication system of claim 1, further including one or more antennas with a cross-sectional area greater than 0.2 square metres.

7. A communication system of claim 1, wherein information is transmitted intermittently or in periodic bursts.

8. A communication system of claim 1, wherein information is transmitted in response to a change of state of equipment that is being monitored.

9. A system of claim 1, wherein information is transmitted is response to a request from another site.

10. A system of claim 1, wherein at least a portion of the communication path between the transmitter and the receiver is below ground and at least a portion is above ground.

11. A system of claim 1, wherein information about a remote state of equipment is transmitted on average less often than ten times per second.

12. A system of claim 1, wherein signal or information bandwidth is less than 10 Hz.

13. A system of any of claim 1, wherein the receiver is operable to filter or average a signal to reduce noise effects.

14. A system of claim 1, wherein information transmitted includes a unique encoding and/or modulation and/or signal frequency and/or combination of signal frequencies that indicates the source and/or destination of the information.

15. A system of claim 1, further comprising:
one or more intermediate stations for relaying signals between the transmitter and the receiver.

16. A system of claim 1, wherein information is transmitted occasionally for to verify a continued operability of a site.

17. A system of claim 1, further comprising:
a data interface to receive data for digitally modulating electromagnetic or magnetic signals.

18. A system of claim 17, wherein the data is control data for equipment that is controlled at a remote location from the system.

19. A system of claim 17, wherein the data is state or condition data indicative of a state or condition of equipment that is monitored.

20. A monitoring system, comprising:
at least one sensor or detector for sensing a state or condition that is monitored, and
a transmitter for transmitting a digitally modulated electromagnetic or magnetic signal indicative of the state or condition.

22. A communication method, comprising:
transmitting a signal from a transmitter to a receiver, at least one of the transmitter and receiver having a magnetically coupled antenna, and
wherein at least one of the transmitter and receiver is located underground and at least part of a communication path is underground.
